(19) United States
(12) Patent Application Publication
(10) Pub. No.: US 2013/0095965 A1
(43) Pub. Date: Apr. 18, 2013

(54) CHAIN TENSION GUIDE SUITABLE FOR AN INTERNAL COMBUSTION ENGINE

(71) Applicant: E I DU PONT DE NEMOURS AND COMPANY, Wilmington, DE (US)

(72) Inventors: Shin-Ichi Nakagawa, Utsunomiya (JP); Bunichi Rai, Tokyo (JP); Kaori Iwamoto, Utsunomiya (JP); Satoru Sekiguchi, Utsumomiya (JP)

(73) Assignee: E I DU PONT DE NEMOURS AND COMPANY, Wilmington, DE (US)

(21) Appl. No.: 13/650,163

(22) Filed: Oct. 12, 2012

Related U.S. Application Data
(60) Provisional application No. 61/548,355, filed on Oct. 18, 2011.

(51) Int. Cl. F16H 7/08

(52) U.S. Cl. CPC F16H 7/08
USPC 474/111

(57) ABSTRACT

A chain tension comprising a guide body wherein the guide body comprises a layer made of a non-thermoplastic polyimide on at least part of the chain guiding face.

### CROSS-REFERENCE TO RELATED APPLICATIONS

This application claims the benefit of priority from U.S. Provisional Application No. 61/548,355, filed Oct. 18, 2011, which is incorporated herein by reference in its entirety.

### BACKGROUND OF THE INVENTION

1. Field of the Invention

The present invention pertains to a chain tension guide for a chain transmitting torque from a source of driving force, such as an engine to driven members such as a camshaft of an internal combustion engine so that it extends along a predetermined arch, while proper tension in the chain is maintained by the chain tension guide which can be positioned to bias the guide against the running chain by some activation means.

2. Description of the Related Art

It is known to use a timing chain system in a valve operating system in overhead valve engine to provide the requisite timing for the opening and closing of the valves. The timing chain system has (i) a chain for transmitting torque from a source of driving force to output members and (ii) the chain tension guide including a guide body, wherein the chain is connected by articulated links arranged with a substantially constant pitch. It is well known that such systems comprise a chain tensioner 11, tension guides 12 and a chain 13, shown in FIG. 1.

For the chain, metal chains are principally used for transmitting torque between the driveshafts and camshafts of automobile engines. In general, three types of chains are used in these engines: silent chains, bushed chains and roller chains. Of these, roller chains provide superior transmission efficiency because they have rollers that can turn independently.

Whatever the style of chain, it is used with a number of members called guides or levers as a mechanism for controlling the sides of the chain and stabilizing its rotation. This is the aforementioned chain tension guide. This chain tension guide has a surface that contacts the chain directly, and the chain, lubricated with engine oil, slides along this contact surface.

In the aforementioned timing chain system, due to the chain tension guide being slidabiy engaged with one strand of the chain most of time during operation, such guide may experience high temperatures and extreme friction, resulting in high rates of wear imposed on the guide and any related timing chain system. After prolonged use, wear to the components of the timing chain system results in a steady decrease in chain tension. Consequently, damage may be incurred because the camshaft timing is misaligned due to the considerable variation in chain tension. Energy loss from the chain tension guide is another factor that cannot be ignored when considering the efficiency of the engine as a whole.

At present, aliphatic nylon resins with excellent wear resistance characteristics, such as the thermoplastic resin nylon 66, are principally used for the sliding surface that contacts the chain. However, unlike the widely-used chain guides (or levers) described above, a chain tension guide for an internal combustion engine such as that disclosed by Hotta et al (Japanese Patent Application Laid-open No. 10-288249) requires extremely advanced sliding properties on the chain contact surface where the guide must support the roller parts of the chain, and the endurance time is extremely short using the aliphatic nylon resin described above. In fact, no suitable material for use on this sliding surface has been disclosed.

Kurihara et al (Japanese Utility Model Application Laid-open No. 61-122445) disclose a roller chain having sliding rollers, but although the sliding environment is less demanding when contacting links outside and/or inside the chain simultaneously, the effect of decreasing friction loss is limited.

Maeda (Japanese Patent Application Laid-open No. 2005-112871) reports that a sliding resin comprising 0.5 to 20 vol % of a solid lubricant such as polytetrafluoroethylene or graphite and 0.5 to 25 vol % of hard components such as alumina added to a thermoplastic resin matrix of nylon 66 or the like provide high wear resistance and reduced friction loss as a sliding resin material for a chain tension guide. Applicants note that in Maeda although a “thermosetting resin” is described, the disclosure may contain an error since nylon 66 resin is given as a typical example).

Ohta et al (Japanese Patent Application Laid-open No. 2007-177037) report that a chain tension guide or the like with excellent friction characteristics and wear resistance is obtained by adding 5 to 40% of a fluoresin with a specific surface energy and visible light transmittance (600 nm) to a thermoplastic resin (nylon 66 resin or the like) used as the matrix resin in a slide member that is used for a chain system and comprises a matrix composition.

However, all of these cases merely involve the addition of additives to a thermoplastic resin such as nylon 66 or the like, which is a widely used material of sliding members, in order to improve its characteristics.

### SUMMARY OF THE INVENTION

Disclosed herein is a chain tension guide comprising a guide body having a chain guiding face for slidably guiding the a chain in the longitudinal direction of the guide body slidably such that the chain is in contacted with the surface of the chain guiding face during each travel of the chain on the guide body, wherein the guide body comprises a layer made of a non-thermoplastic polyimide on at least part of the chain guiding face.

### BRIEF DESCRIPTION OF THE DRAWINGS

FIG. 1 is a schematic view of the timing chain system, indicating the relationship between the chain and the chain tension guide.

FIG. 2 is a perspective view of an example of a chain tension guide.

FIG. 3A is one example of a section view of a chain tension guide along the direction perpendicular to the longitudinal direction of a chain tension guide.

FIG. 3B is another example of a section view of a chain tension guide along the direction perpendicular to the longitudinal direction of a chain tension guide.

FIG. 4A is a side view of a test apparatus for measuring coefficient of friction and total wear height after step loading test.

FIG. 4B is a top view of mating material blocks on a retainer ring of a test apparatus for measuring coefficient of friction and total wear height after step loading test.

FIG. 5A is a schematic view of an actual contact condition between a roller chain and a chain tension guide.

FIG. 5B is a contact model derived from FIG. 5A.

FIG. 6 is a schematic view for clarifying a measuring principle of coefficient of friction.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

It is an object of this invention to provide a new chain tension guide to reduce the friction loss in view of improving engine efficiency and fuel consumption performance.

This object is achieved by a chain tension guide for tensioning an endless power transmission element of a chain having articulated links arranged with a substantially constant pitch and pivotably connected to one another on an internal combustion engine, comprising a guide body having a chain guiding face for guiding the chain in the longitudinal direction of the guide body slidably such that the chain is contacted with the surface of the chain guiding face during each travel of the chain on the guide body, wherein the guide body comprises a layer made of a non-thermoplastic polyimide on at least part of the chain guiding face.

The chain tension guide of the present invention comprises a guide body having a chain guiding face wherein the guide body comprises a layer made of a non-thermoplastic polyimide on at least part of the chain guiding face.

The chain tension guide according to the present invention may encompass a chain tension lever as well, and may be used with any given chain drives and in particular to high speed drives such as camshaft drives in internal combustion engines.

The invention will provide the chain tension guide suitable for an internal combustion engine with energy and friction loss being reduced and will also improve engine efficiency and fuel consumption performance.

(1) Chain Tension Guide

The chain tension guide of the present invention is for tensioning an endless power transmission element of a chain having articulated links arranged with a substantially constant pitch and pivotably connected to one another on an internal combustion engine.

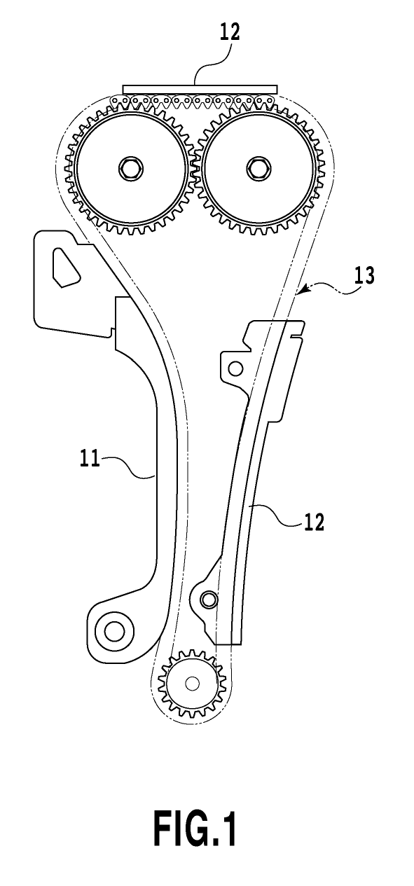

FIG. 1 shows one example of the structure of chain 13, chain tensioner 11 and chain guide 12, which are used in driving an automobile internal combustion engine. One chain tensioner and one or multiple chain guides (2 in FIG. 1) are normally used for each connected chain system to stabilize the chain drive and control life expectancy loss and noise due to poor tension.

The chain tension guide of the present invention encompasses all these chain tensioners and chain guides, but selective application is also possible.

The chain in FIG. 1 is a roller chain and the roller chain comprises multiple rollers which rotate independently from inter and outer links.

A span of the roller chain extends around the sprockets of a power transmission system of internal combustion engine containing a drive sprocket to provide a driving or driven connection between the chain and the sprocket. In the conventional manner, the chain passes in a loop around other sprockets on driving/driven shafts and or idler shafts (not shown) so that torque is transferred from one shaft to the other,

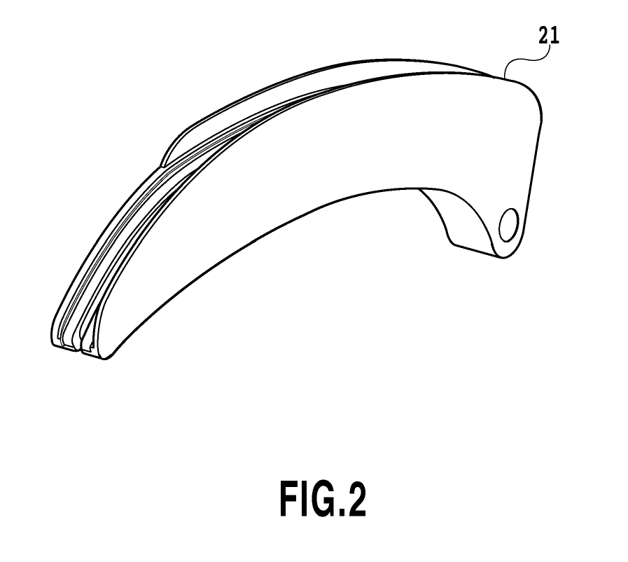

In a conventional power transmission system for internal combustion engine the chain tension guide are slidably engaged with one strand of the chain. FIG. 2 shows the shape of chain tension guide 21, which is a sample for illustrating the shape of a chain tension guide. Chain tension guide 21 is of a shape that is currently in mass production.

The chain tension guide of the present invention can be applied to a silent chain, bushed chain or roller chain.

(2) Guide Body

The chain tension guide of the present invention is provided with a guide body. The guide body has a chain guiding face, and the chain guiding face is for guiding the chain in the longitudinal direction of the guide body slidably such that the chain is contacted with the surface of the chain guiding face during each travel of the chain on the guide body

A layer of the non-thermoplastic polyimide described under (3) below is provided on at least part of this chain guiding face. Because of the low-friction properties and high wear resistance of non-thermoplastic polyimide, energy loss can be adequately reduced even in the chain tension guide of an internal combustion engine, resulting in increased engine efficiency and fuel savings.

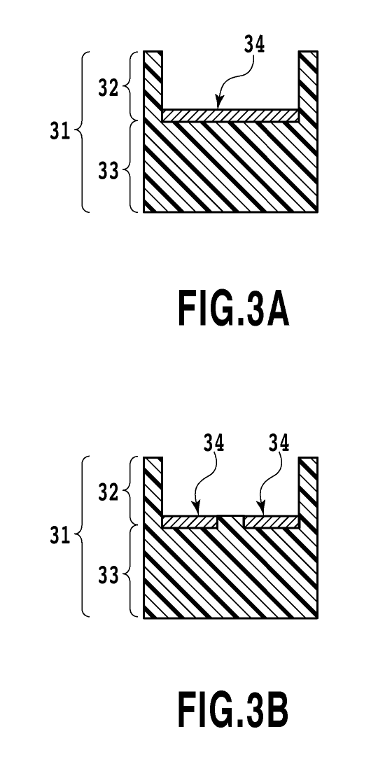

Guide body 31 is normally provided (as shown in FIG. 3 for example) with holding part (holder) 33 for maintaining the shape of the guide as a whole and sliding part (which means a part forming a passage for a chain) 32, which is the layer providing the chain guiding face. The same material can also be used for the holding part 33 and sliding part 32 in cases in which the sliding load is low. In most cases, however, different materials are used for the holding part 33 and sliding part 32, and because of the dimensional changes that occur due to thermal expansion, the sliding part 32 preferably has a shape that allows it to move somewhat relative to the holding part 33 so that it can absorb strain caused by differences in linear expansion coefficient. More particularly, the sliding part 32 is preferably embedded in a channel formed in the holding part 33, for example, allowing it to move freely to a certain degree in the longitudinal direction, which is most affected to differences in linear expansion coefficient.

A die-cast or other metal or a fiberglass-reinforced nylon resin with superior fatigue properties can be used as the material of the holding part 33. The sliding part 32 may consist entirely of a layer of non-thermoplastic polyimide, but will generally function if it has layer 34 of non-thermoplastic polyimide on only that part that contacts the chain. Costs can be greatly reduced with this structure. An injection-moldable thermoplastic resin such as nylon 66 or another non-reinforced aliphatic nylon resin can normally be used for the sliding part except layer 34 of non-thermoplastic polymer.

The chain guiding face of the sliding part 32 may be flat in the direction perpendicular to the chain drive direction as shown in FIG. 3A, but may also have a convex part (the longitudinally extending chain sliding rail) in the center, or may be structured so that only the ends of this convex part contact the chain roller parts of the chain as shown in FIG. 3B.

In this case, one possibility is to configure only the longitudinally extending chain sliding rail as a layer of non-thermoplastic polyimide. The longitudinally extending chain sliding rail may be moveable longitudinally at least to some extent to adjust dimensional variation due to thermal expansion of the respective components of the timing chain system. Particularly in the case of an engine driven by a roller chain with rollers that rotate freely rather than being following the chain drive, it is desirable to have a longitudinally extending chain sliding rail that simultaneously contacts only multiple continuous roller parts of the roller chain. The longitudinally extending chain sliding rail may be given a shape with curvature for contacting the chain roller, but this curvature is not particularly limited. The length of the longitudinally extending chain sliding rail is not particularly limited except by the fact that it must simultaneously contact multiple chain rollers.

FIG. 3A and FIG. 3B each show other examples having layer 34 formed of non-thermoplastic polyimide on sliding part 32.

Because it is normally difficult to mold the non-thermoplastic polyimide of the sliding part and the thermoplastic resin of the body part simultaneously, the manufacturing method may involve separate molding of the non-thermoplastic polyimide part and thermoplastic resin part, combined with machine finishing as necessary. In this case, the two may be integrated by snap fitting, fastened with screws or affixed with an adhesive. When the glass transition temperature or thermal deformation temperature of the non-thermoplastic polyimide is higher than the molding temperature of the thermoplastic resin, they can also be integrated by insert molding of the thermoplastic resin, with the molded non-thermoplastic polyimide member fixed in an injection mold. Because the raw materials for molding the non-thermoplastic polyimide itself are normally in suitable form, such as powdered form, they can be molded by compression molding and baking inside the mold or by simultaneous application of high heat and pressure, and extrusion molding is also possible depending on the equipment and conditions.

(3) Non-Thermoplastic Polyimide

Non-thermoplastic polyimide is polyimide that has a 2-dimensional linear molecular structure but has no thermal melting property.

Thermal melting property here means the reversible property of becoming fluid as the temperature rises above the Tg, or Tm, and solidifying again as the temperature falls; non-thermoplastic polyimides are not heat-melting either because they do not exhibit a clear Tg or Tm, or because the Tg, or Tm is so high that the material exhibits conspicuous thermal decomposition at or below these temperatures.

Polyimide resins include non-thermoplastic polyimides, thermoplastic polyimides and thermosetting polyimides.

Like thermoplastic polyimides, non-thermoplastic polyimides have a two-dimensional linear molecular structure, but unlike thermal melting thermoplastic polyimides (thermoplastic polyimide (TPI), polyamidimide (PAI), polyetherimide (PEI) and the like), they have no thermal melting property. More specifically, the non-thermoplastic polyimide is used to describe a polyimide component that has a glass transition temperature greater than 280° C., preferably greater than 350° C., and more preferably greater than 400° C., and no discernable glass transition temperature in temperatures up to at least 400° C. (On the other hand, as used herein the term thermoplastic polyimide is used to describe a polyimide component that has a glass transition temperature less than or equal to 280° C., preferably less than 250° C.

Thermosetting polyimides, such aspolyamino bismaleimide (PABM), and the like, are distinguished by chemical structure from non-thermosetting polyimides in that they have unsaturated groups at the termini of the resin molecules, and are crosslinked by an addition reaction or radical reaction that gives them a three-dimensional network structure.

The non-thermoplastic polyimide used in the chain tension guide of the present invention generally has a low friction coefficient and a high wear resistance, but is characterized in particular by a low friction coefficient and little change in the size of the load under actual drive conditions at or above the sliding speed on the chain tension guide.

The polyimide contains the characteristic —CO—NR—CO— group as a linear or heterocyclic unit along the main chain of the polymer backbone. The polyimide can be obtained, for example, from the reaction of monomers such as an organic tetracarboxylic acid, or the corresponding anhydride or ester derivative thereof, with an aliphatic or aromatic diamine.

Non-thermoplastic polyimide can be synthesized as linearly-polymerized polyimide in a manner that an aromatic tetracarboxylic acid or the derivatives thereof and an aromatic diamine or aromatic diisocyanate are solution-polymerized to form a polyamic acid derivative and then the polyamic acid derivative is to the imidization by crystallization and dehydrogenation at high temperature.

A polyimide precursor as used to prepare a polyimide is an organic polymer that becomes the corresponding polyimide when the polyimide precursor is heated or chemically treated. In certain embodiments of the thus-obtained polyimide, about 60 to 100 mole percent, preferably about 70 mole percent or more, more preferably about 80 mole percent or more, of the repeating units of the polymer chain thereof has a polyimide structure as represented, for example, by the following formula:

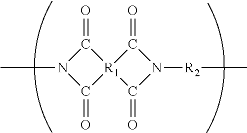

wherein R₁ is a tetravalent aromatic radical having 1 to 5 benzenoid-unsaturated rings of 6 carbon atoms, the four carbonyl groups being directly bonded to different carbon atoms in a benzene ring of the R₁ radical and each pair of carbonyl groups being bonded to adjacent carbon atoms in the benzene ring of the R₁ radical; and R₂ is a divalent aromatic radical having 1 to 5 benzenoid-unsaturated rings of carbon atoms, the two amino groups being directly bonded to different carbon atoms in the benzene ring of the R₂ radical.

Preferred polyimide precursors are aromatic, and provide, when imidized, polyimides in which a benzene ring of an aromatic compound is directly bonded to the imide group. An especially preferred polyimide precursor includes a polyamic acid having a repeating unit represented, for example, by the following general formula, wherein the polyamic acid can be either a homopolymer or copolymer of two or more of the repeating units:

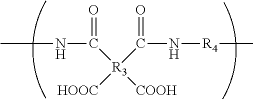

wherein R₃ is a tetravalent aromatic radical having 1 to 5 benzenoid-unsaturated rings of 6 carbon atoms, the four carbonyl groups being directly bonded to different carbon atoms in a benzene ring of the R₃ radical and each pair of carbonyl groups being bonded to adjacent carbon atoms in the benzene ring of the R₃ radical; and R₄ is a divalent aromatic radical having 1 to 5 benzenoid-unsaturated rings of carbon atoms, the two amino groups being directly bonded to different carbon atoms in the benzene ring of the R₄ radical.

Typical examples of a polyamic acid having a repeating unit represented by the general formula above are those obtained from pyromellitic dianhydride (“PMDA”) and diaminodiphenyl ether (“ODA”) and 3,3′,4,4′-biphenyltetracarboxylic dianhydride (“BPDA”) and ODA. When subjected to ring closure, the former becomes poly(4,4′-oxydiphenylenepyromellitimide) and the latter becomes poly(4,4′-oxydiphenylene-3,3′,4,4′-biphenyltetracarboxy imide).

Apart from the poly(4,4′-oxydiphenylene pyromellitimide), the polymer melting point or glass transition temperature (Tg) >400° C.] mentioned above, other examples of the non-thermoplastic polyimide include poly(BPDA-ODA) (Upimol™, Tg=285° C., Ube Industries Ltd.), in which biphenyl dianhydride (BPDA) is substituted for PMDA, and poly(BPDA-PPD) (Upimol™, Tg>400° C., Ube Industries Ltd.), in which p-phenylenediamine (PPD) is further substituted for ODA, as well as an improved product (Upimol SA™, Ube Industries Ltd.) in which asymmetrical BPDA is substituted for part of the BPDA and the like. Properties of Upiomol™ polyimide are indicated in Ube's brochure.

The poly(BPDA-co(PPD; MPD)) used in the example also belongs to the category of non-thermoplastic polymers.

Structurally speaking, non-thermoplastic polyimides of the present invention include wholly aromatic polyimides, which are polyimides in the narrow sense of the word, and these wholly aromatic polyimides are preferably non-thermoplastic polyimides. A wholly aromatic polyimide here is an aromatic polyimide that has an imide group directly bound to an aromatic ring, and that either contains no aliphatic carbon, or has no hydrogen directly bound to the carbon if such is present.

On the other hand, of the non-thermoplastic polyimides, a polyimide base polymer that can be composed of the aromatic diamine and/or aromatic diisocyanate, which are themselves known to the art. Preferred is p-phenylenediamine (PPD), m-phenylenediamine (MPD), 4,4′-oxydianiline (ODA), 4,4′-methylendiaminen (MDA),

As the aromatic tetracarboxylic acid component, there can be mentioned aromatic tetracarboxylic acids, acid anyhydrides thereof, salts therof and ester thereof. Preferred is an aromatic tetracarboxylic dianydride, and particularly preferred is a pyromellititic dianhydride (PMDA), 3,3′,4,4′-biphenyltetracarboxylic dianhydride (BPDA) or 3,3′,4,4′-benzophenone tetracarboxylic dianhydride (BTDA).

Such polyimide are available from E. I. du Pont de Nemours and Company, under the trademark Vespel® polyimide and BPDA based polyimide from Ube Industries Ltd., under the trademark Upimol ® or UIP . . . and, BTDA based polyimide resin grade No.P84 from HP Polymer GmbH.

Of the polyimide base polymers that can be composed of the aromatic diamine 4,4′-oxydianiline and the aromatic tetracarboxylic acid dianhydride pyromellitic acid dianhydride, the wholly aromatic polyimide poly-4,4′-oxydiphenylenepyromellitic acid amide [poly(PMDA-co-ODA)] is preferred. Poly-4,4′-oxydiphenylenepyromellitic acid amide exhibits a low friction coefficient and high wear resistance in both high-speed and low-speed operating environments, and also has stable low friction and high wear resistance characteristics regardless of the size of the load in both high-speed and low-speed operating environments.

The disclosure of the present invention is further illustrated by the following example:

### EXAMPLE

A step loading and speed test was performed, and the friction coefficients and wear resistance of the various materials were measured.

(1) Apparatus

Thrust Type Wear & Friction Tester

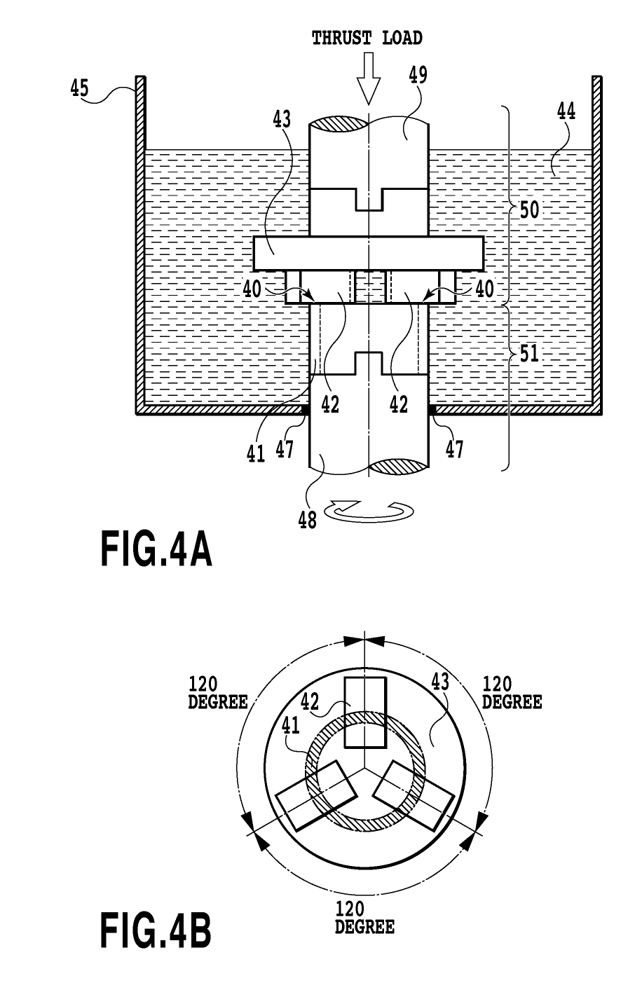

FIG. 4A and FIG. 4B are schematics illustrating the wear and friction tester used to measure wear and coefficient of fraction of various test specimens, designed and fabricated and under conditions according to JIS (Japanese Industrial Standard) K7218, titled “Testing Methods for Sliding Wear Resistance of Plastics.”

More specifically, the following test methods represent descriptions of methods that can be used to measure coefficient of friction and wear used throughout this disclosure and were used in the following Examples.

Wear tests were performed using the tester according to the present invention, which is depicted in FIG. 4A and FIG. 4B. The equipment is described in JIS K7218.

Each test specimen 41 as a model of the chain tension guide was prepared in cylindrical or hollow form having an outside diameter of about 25.6 mm, a height of about 15 mm and wall thickness of about 2.8 mm by machining or injection molding depending on polymer compositions.

A mating material block (Cylindlical shape, Length: 50 mm; Diameter: 15 mm; as a model of a roller chain is made of S45C carbon steel and three such mating material blocks were mounted on a retainer ring 43 by a rigid frame along a radial direction of the retainer ring in such a way that an angle at which any adjacent pair of the radial directions meet is 120 degrees as shown in FIG. 4B, and each mating material block was located between the inside diameter of 10 mm and the outside diameter of 60 mm along each radial direction on the retainer ring 43.

After weighing the test specimen 41, the test specimen was mounted on a rotatable shaft 48. Then, the retainer ring 43 with three mating material blocks 42 was mounted on the test specimen so that the test specimen was against the mating material blocks 42 fixed on the retainer ring 43, while the mating material blocks was loaded against the test specimen 41 through a shaft 49 and the retainer ring 43 with the selected test pressure and the rotatable shaft 48 was rotating at a desired speed, as shown in FIG. 4A. Lubricant Oil (Castle Oil 0W-20) 44 in an oil bath 45, with engine oil (44) with the bath having an oil seal 47 was used between the mating surfaces.

The friction force was recorded continuously through the shaft 49 connected with the retainer ring 43 with the mating material blocks 42 so as to prevent the rotation of the shaft 49. Thus, the part 50 constitues the non-rotating part, while the the part 51 constitues a rotating part.

Point 40 in FIG. 4A is a contact point of the test specimen with the mating material block 42.

(2) Conditions for Measurement

The conditions 1 to 16 for a test specimen are summarized in Table 1.

The measurement for one test specimen was carried out under conditions 1 to 16 in sequence. The total measurement time was 80 min.

TABLE 1
Condition for measurement

| | Thrust | Revol- | Sliding | Holding | Cumulative |
|---|---|---|---|---|---|
| Condi- | Load | ution | Speed* | Time | Measurement |
| tion | (N) | (rpm) | (m/sec) | (min) | Time (min) |
| 1 | 23 | 1,200 | 1.6 | 5 | 5 |
| 2 | 50 | 1,200 | 1.6 | 5 | 10 |
| 3 | 100 | 1,200 | 1.6 | 5 | 15 |
| 4 | 200 | 1,200 | 1.6 | 5 | 20 |
| 5 | 23 | 2,400 | 3.1 | 5 | 25 |
| 6 | 50 | 2,400 | 3.1 | 5 | 30 |
| 7 | 100 | 2,400 | 3.1 | 5 | 35 |
| 8 | 200 | 2,400 | 3.1 | 5 | 40 |
| 9 | 23 | 4,000 | 5.2 | 5 | 45 |
| 10 | 50 | 4,000 | 5.2 | 5 | 50 |
| 11 | 100 | 4,000 | 5.2 | 5 | 55 |
| 12 | 200 | 4,000 | 5.2 | 5 | 60 |
| 13 | 23 | 6,400 | 8.4 | 5 | 65 |
| 14 | 50 | 6,400 | 8.4 | 5 | 70 |
| 15 | 100 | 6,400 | 8.4 | 5 | 75 |
| 16 | 200 | 6,400 | 8.4 | 5 | 80 |

*Sliding speed V(m/s) = paixnxD/60000 where n = rpm(revolution per minute) and D = average diameter of test specimens (mm).

Under a constant revolving speed at 1,200 rpm of the rotatable shaft 48 and the test specimen 41, the mating materials 42 were pressed against the revolving test specimen 41 in an oil bath 45 filled with engine oil 44 (Castle 0W-20) of which temperature was 120 degrees C., while each specific load 23, 50, 100 or 200 N (thrust load) was applied to the mating materials 42 for 5 minutes in a step-wise fashion (20 minutes in total) so that the load was raised up from 23 N to 200 N. These processes correspond to the conditions 1 to 4 in Table 1.

Similar process was repeated with the same sample employed in the conditions 1 to 4 in Table 1 having the same conditions except that the revolution speed of rotatable shaft 48 and the test specimen 41 was raised up to 2,400 rpm (conditions 5 to 8 in Table 1), 4,000 rpm (conditions 9 to 12) and then 6,400 rpm (conditions 13 to 16) in a step-wise fashion.

Tester described in FIG. 4 A and FIG. 4B simulate a situation close to those in an actual chain tension guide.

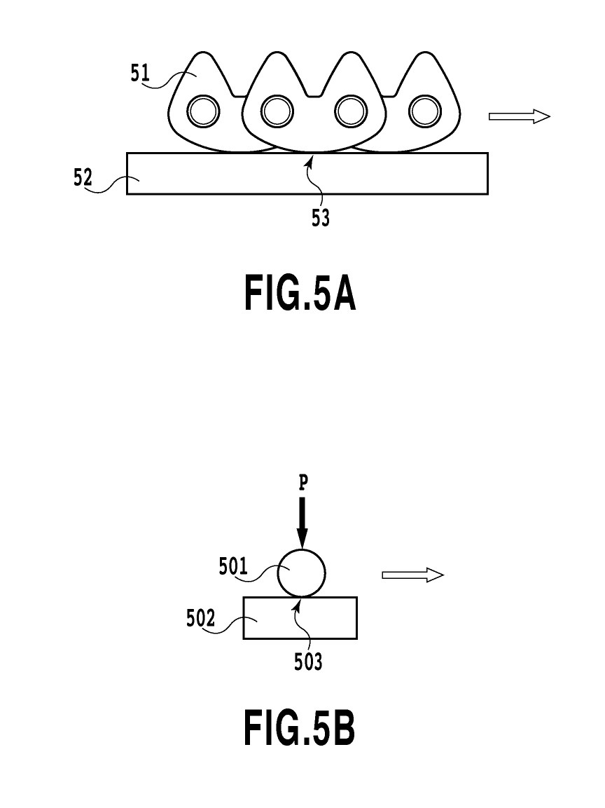

In an actual contact condition, a chain 51 slides on a chain tension guide 52 (FIG. 5A). Point 53 in FIG. 5A is a contact point of the guide 52 with the chain 51.

This condition may be simulated by a mating material block 501 and a test specimen 502, where the mating material block slides relatively on the test specimen 502 (FIG. 5B), or equivalently, the test specimen 502 relatively slides on the mating material block 501. Point 503 in FIG. 5B is a contact point of the test specimen 502 with the mating material block 501.

The test specimen 41 was rotated on surface of the mating material blocks 42 at a constant speed to be controlled at 5.2 m/sec or 8.4 m/sec by a rotating apparatus. In other words, the test specimen 41 was rotated at a constant speed of 4000 rpm or 6400 rpm while holding the mating material blocks 42 stationary so that friction force F can be measured.

In order to more nearly simulate a valve operating system in which a chain is sliding in contact with a chain guide at speed in proportion to engine speed, the revolving speed in the tester under which the test specimens were slidably contacted with the mating material blocks was more than 4,000 rpm.

(3) Test Specimen
Material:
   Commercially available Non-thermoplastic polyimide
      poly (PMDA-ODA), Tg>400° C.
      poly (BPDA-PPD), Tg>400° C.
      poly [BPDA-(PPD;MPD] c, Tg=340° C.

### Comparative Thermoplastic Polymer

Polytetrafluoroethylene (PTFE) commercially available (e.g. TEFLON®) from Mitsui-DuPont Fluorochemicals Co., Ltd., Japan

Polyamide (PA), commercially available from E.I. du Pont de Nemours and Company, DE, USA under the common trade name ZYTEL®

PMDA=pyromellitic acid dianhydride

ODA=4,4′-oxydianiline

BPDA=biphenyltetracarboxylic acid dianhydride

PPD=p-phenylenediamine

MPD=3-methylpentane-1,5-diol

PTFE=polytetrafluoroethylene

PA=polyamide

(4) Results

(4-1) Coefficient of Friction at the Temperature of 120 degrees C.

The coefficient of friction (Cf) is defined by the following equation:

Cf=P×r/F×1

where: P (N)=Thrust load ranging from 23 to 200 N as shown in Table 2,

r (mm)=Semi-diameter between rotation axis and sliding part where the mating material blocks are slidably contacted with a text specimen,

F(N)=Friction forces, and

1 (mm)=Arm length of friction force detection.

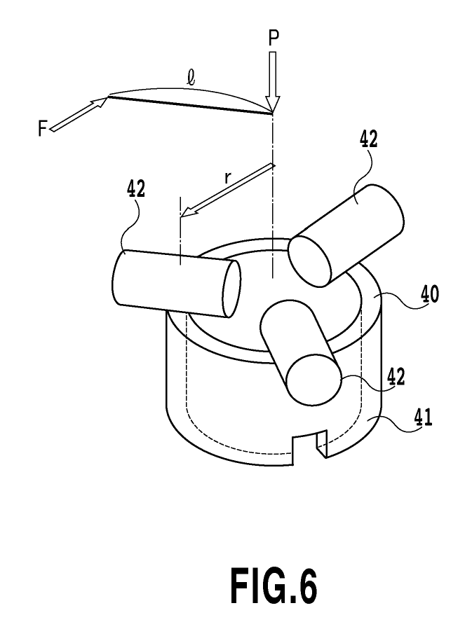

FIG. 6 indicates these symbols in the equation.

TABLE 2
Coefficient of Friction under a constant revolving speed at 4,000 rpm

| Revolving Speed | 4,000 rpm | | | |
|---|---|---|---|---|
| Thrust Load | 23N | 50N | 100N | 200N |
| 1 Poly(PMDA- | 0.0191 | 0.0189 | 0.0191 | 0.0189 |
| ODA) | | | | |
| 2 Poly[BPDA- | 0.0378 | 0.0309 | 0.0362 | 0.0320 |
| (PPD; MPD)] | | | | |
| 3 Comparative | 0.0378 | 0.0328 | 0.0369 | 0.0481 |
| PTFE | | | | |
| 4 Poly(BPDA-PPD) | 0.0347 | 0.0363 | 0.0382 | 0.0406 |
| 5 Comparative PA | 0.0721 | 0.0507 | 0.0457 | 0.0334 |

TABLE 3
Coefficient of Friction under a constant revolving speed at 6,400 rpm

| Revolving Speed | 6,400 rpm | | | |
|---|---|---|---|---|
| Thrust Load | 23N | 50N | 100N | 200N |
| 1 Poly(PMDA-ODA) | 0.0275 | 0.0218 | 0.0196 | 0.0186 |
| 2 Poly[BPDA- | 0.0400 | 0.0286 | 0.0268 | 0.0273 |
| (PPD; MPD)] | | | | |
| 3 Comparative PTFE | 0.0461 | 0.0367 | 0.0413 | 0.0482 |
| 4 Poly(BPDA-PPD) | 0.0389 | 0.0372 | 0.0355 | 0.0395 |
| 5 Comparative | 0.0835 | 0.0588 | 0.0381 | 0.0311 |
| PA | | | | |

As shown in Table 2 and Table 3, non-thermoplastic polyimide such as poly(PMDA-ODA), poly(BPDA-PPD) and poly[BPDA-(PPD;MPD)] generally have advantages at the higher revolving speed as follows:

(i) The coefficient of friction is much lower at the higher revolving speed (not less than 4000 rpm) than those at the lower revolving speed (not more than 2400 rpm) By means of the fact that non-thermoplastic polyimide generally has a low coefficient of friction, it is possible to make the coefficient of friction lower in the case where the coefficient of friction decreases as the speed increase, specially, in the case of using non-thermoplastic polyimide, in a range where the revolving speed is not less than 4000 rpm; and

(ii) The load between 23 to 200 N does not change the coefficient of friction of the non-thermoplastic polymer so much at the higher revolving speed (not less than 4000 rpm), compared to those of polyamide at the same revolving speed.

Moreover, poly(PMDA-ODA) always shows the lowest and most stable friction in any conditions.

(5-2) Total Wear Height after Step Loading Test at the Temperature of 120 degrees C.

The total wear height of each test specimens corresponds to the height difference of each test specimen between an original height and a height after the test.

The weight loss is a loss in weight of the test specimen during the step loading test

TABLE 4

| Test Specimen | Total Wear Height (mm) |
|---|---|
| 1 Poly(PMDA-ODA) | 0.010 |
| 2 Poly[BPDA-(PPD; MPD)] | 0.080 |
| 3 Comparative PTFE | 0.767 |
| 4 Poly(BPDA-PPD) | 0.101 |
| 5 Comparative PA | 0.115 |

Specimen 4 [Poly(BPDA-PPD)] and Specimen 2 [Poly[BPDA-(PPD;MPD)] show comparable total wear height to Specimen 5, PA.

Moreover, Specimen 1 [poly(PMDA-ODA)] shows much less wear than the any other materials.

As widely known and recognized, friction generated in driving and transmission systems of vehicles causes fuel consumption to increase and gives adverse effect on the engine efficiency. Such remarkable reduced friction in the system improves fuel consumption.

What is claimed is:

1. A chain tension guide comprising a guide body having a chain guiding face for slidably guiding a chain in the longitudinal direction of the guide body such that the chain is in contact with the surface of the chain guiding face during each travel of the chain on the guide body, wherein the guide body comprises a layer made of a non-thermoplastic polyimide on at least part of the chain guiding face.

2. A chain tension guide according to claim 1, wherein the entire guide body comprises the non-thermoplastic polyimide.

3. A chain tension guide according to claim 1, wherein the non-thermoplastic polyimide is a wholly aromatic polyimide.

4. A chain tension guide according to claim 1, wherein the non-thermoplastic polyimide comprises a polyimide base polymer (PI) derived from a diamine and a dianhydride.

5. A chain tension guide according to claim 4, wherein the diamine is 4,4′-oxydianiline and the dianydride is pyromellitic dianhydride.

6. A chain tension guide according to claim 5, wherein the non-thermoplastic polyimide is poly-4,4′-oxydiphenylenepyromellitic acid amide.

7. A chain tension guide according to claim 1, wherein the non-thermoplastic polyimide is selected from the group consisting of poly(pyromellitic dianhydride-oxydianiline), poly(3,3′,4,4′-biphenyltetracarboxylic dianhydride—p-phenylenediamine), and poly[3,3′,4,4′-biphenyltetracarboxylic dianhydride—(p-phenylenediamine, m-phenylenediamine).

8. A chain guide according to claim 1, wherein the chain tension guide is for tensioning an endless power transmission element of a chain having articulated links arranged with a substantially constant pitch and pivotably connected to one another on an internal combustion engine.
